(19) United States
(12) Patent Application Publication
(10) Pub. No.: US 2026/0287874 A1
(43) Pub. Date: Sep. 24, 2026

(54) APOCHROMATIC IMMERSION OBJECTIVE

(71) Applicant: Carl Zeiss Microscopy GmbH, Jena (DE)

(72) Inventor: Jörg SPRENGER, Göttingen (DE)

(21) Appl. No.: 19/565,689

(22) Filed: Mar. 13, 2026

(30) Foreign Application Priority Data
Mar. 20, 2025 (DE) 10 2025 110 877.3

(51) Int. Cl. G02B 21/02; G02B 13/00

(52) U.S. Cl. CPC G02B 21/02; G02B 13/006

(57) ABSTRACT

An apochromatic immersion objective has a plurality of lenses, which form multiple subsystems with a plurality of lens groups. The first subsystem has an opened-up triplet group with a singlet lens and a cemented doublet element. The absolute value of the radius of curvature of the surface of the singlet lens facing the cemented doublet element is greater than the absolute value of the radius of curvature of the surface of the cemented doublet element facing the singlet lens. A plurality of the lenses form cemented elements. A plurality of the cemented elements have lenses made of glasses with a refractive index difference of more than 0.3. At least two cemented elements have converging cemented surfaces.

### CROSS-REFERENCE TO RELATED APPLICATION

This application claims benefit under 35 U.S.C. § 119 to German Application No. 10 2025 110 877.3, filed Mar. 20, 2025. The entire disclosure of this application is incorporated by reference herein.

### FIELD

The disclosure relates to an apochromatic immersion objective. The disclosure also relates to a microscope with such an objective.

### BACKGROUND

EP 3 557 305 A1 discloses an immersion objective with a high numerical aperture NA≥1.4 and good chromatic correction in the spectral range of 405-656 nm. However, even for relatively small object fields of less than ⅔ of the field of view, the coma correction seems relatively severely impaired by higher-order aberrations, as demonstrated in the image field correction diagrams.

US 2024/0045192 A1 discloses an immersion objective for confocal microscopy with a high numerical aperture NA≥1.4, but only for the visual spectral range. This objective has an optical working distance AA≤0.15. This is insufficient for certain applications.

Further high-aperture immersion objectives for confocal microscopy are described in DE10 2012 018 698, corresponding to US 2015/0219887 A1. The axial apochromatic correction is carried out for a wavelength range of 365-900 nm, but larger fields of view are dominated by the residual lateral chromatic aberration. The numerical apertures are in the range NA=1.3 to 1.4.

Image aberrations become visible in the edge region of large object fields, particularly in the case of high numerical apertures.

### SUMMARY

The disclosure seeks to improve an apochromatic microscope objective. For example, the disclosure seeks to improve an apochromatic microscope objective with a large working distance. The microscope objective can have relatively good apochromatic correction over a wide wavelength range and can achieve relatively high image quality right up to the edge regions of the field of view.

The objective may be a microscope objective for use with immersion oil, such as standard immersion oil, for example with a refractive index nₑ=1.518.

The objective can have a numerical aperture (NA) of at least 1.4.

On account of the relatively high numerical aperture, a relatively high resolution is achieveable, especially also in the case of use with standard immersion oil.

The objective can have a working distance (AA) of at least 0.18 millimeters (mm).

According to the disclosure, it has been recognized that over a wavelength range from 385 nanometers (nm) to 1000 nm, it is desirable for such an objective to have a lateral chromatic aberration that is at most half as large as the Airy diameter (dairy) of the objective. As an example, in the specified wavelength range, the lateral chromatic aberration can be at most 0.3 times as large as the Airy diameter of the objective.

This can help ensure relatively good apochromatic correction.

A largest possible working distance (AA) can facilitate automated specimen scanning. Optionally, the objective according to the disclosure has a working distance of at least 0.17 mm, such as at least 0.18 mm, for example at least 0.20 mm, for example at least 0.21 mm.

According to the disclosure, it has been recognized that, in the case of a relatively highly resolved capture of a three-dimensional specimen volume, for example in conjunction with laser scanning techniques, the desired properties for image field correction right up to the edge regions are increasing.

It has also been recognized that the desired properties for chromatic correction of the objective are increasing in view of new fluorescent dyes being continuously developed.

An objective according to the disclosure can enable for example improved scanning, such as automated scanning, of a specimen.

An objective according to the disclosure may have a field of view with a diameter of at least 20 mm, such as at least 23 mm, for example at least 25 mm. The field of view is also referred to as image field.

The diameter of the field of view, also referred to as field number, corresponds to the product of the diameter of the object field and the magnification (V) of the objective.

Over a wavelength range from 405 nm to 900 nm, the longitudinal chromatic aberration of the objective can be at most half as large as the Rayleigh length z80 (where z80=nₑ·λ/NA²) according to another aspect.

According to an aspect, the objective has relatively good monochromatic correction right up to the edge regions of the image field. The objective achieves relatively high image quality, especially over a wide image field range.

For example, in the wavelength range from 385 nm to 1000 nm, such as from 450 nm to 800 nm, the objective can have a field curvature (BFW) that is at most 0.5 mm, such as at most 0.3 mm, and/or is at most half as large, such as at most 0.3 times as large, as the Rayleigh length (z80) of the objective. These statements can apply to at least 80%, such as at least 90%, for example at least 95%, of the image field.

According to an aspect, the objective has relatively good coma correction and/or astigmatism correction.

For example, the coma correction can be described using the Nijboer-Zernike coefficients C103 and C105.

Here, C103 characterizes the primary coma. C105 characterizes the secondary coma.

In this notation, C_{m, 2n+m}=C103=C1,3, i.e. m=1 and n=1.

In this notation, C_{m, 2m+m}=C105=C1,5, i.e. m=1 and n=2.

Using the Nijboer-Zernike coefficients C_{m, 2n+m} the wavefront aberration l can be represented in pupil coordinates r, φ as follows:

$$ℓ ( r , φ ) = λ {\sum }_{m = 0}^{M} {\sum }_{n = 0}^{N ( m )} {ε}_{m , n} {C}_{m , 2 n + m} {ℛ}_{m}^{n} ( r ) cos ( m φ )$$

Here,
ε_{m,n} denotes the normalization factor

$${ε}_{m , n} = \frac{1}{π} \sqrt{\frac{2 n + m + 1}{2 ( 1 + {δ}_{m , 0} )}}$$

and

$${ℛ}_{m}^{n} ( r )$$

denotes the Zernike polynomials.

The Nijboer-Zernike coefficient C103 can be at most 0.4 over at least 80% of the image field, in particular over the entire image field, such as at wavelengths in the range from 405 nm to 546 nm. As an example, it is at most 0.25.

Here, C202 characterizes the primary astigmatism and C204 characterizes the secondary astigmatism.

In the C_{m, 2n+m} notation, C202 is C2,2, i.e. m=2, n=0.

In the C_{m, 2n+m} notation, C204 is C2,4, i.e. m=2, n=1.

According to an aspect, the objective can be designed such that the Strehl ratio (DEH) is at least 75% for all wavelengths from 400 nm to 900 nm in the image plane up to an image field of at least two-thirds of the full field of view. In the wavelength range from 450 nm to 900 nm, the Strehl ratio (DEH) for the entire field of view can be at least 80%.

The Strehl ratio (DEH) is defined here by the ratio of the actual intensity in the image space to the intensity that a spherical wave at its origin would produce.

In particular, the Strehl ratio DEH is defined as follows:

$${DEH = \vert \frac{1}{π} {\int }_{0}^{1} {\int }_{0}^{2 π} exp ⌈ \frac{2 π i}{λ} ℓ ] r dr d φ \vert}^{2}$$

It can be approximated by the following sum of the squares of the Nijboer-Zernike coefficients C_{m, 2n+m′}:

$$DEH \approx 1 - {\sum }_{m = 0}^{M} {\sum }_{n = 0}^{N ( m )} {C}_{m , 2 n + m}^{2}$$

According to an aspect, the objective can have a magnification in the range from 50 to 75, such as in the range from 60 to 65. This can hold true for a tube system with a focal length of 195 mm. For example, the value may be the magnification value that is usually specified on the objective.

Generally, the objective has a plurality of lenses (Li; i>1). The lenses Li form multiple subsystems (Tj; j≥1), wherein each of the subsystems may have one or more lens groups (Gk; k≥1).

A lens group may have one or more singlet lenses and/or one or more cemented elements.

Different lens groups are usually separated from one another by an air gap.

A subsystem is understood to mean a functional unit, such as an arrangement of one or more lenses.

An objective according to the disclosure may have three subsystems. For example, it may comprise (or consist of) three subsystems T₁, T₂ and T₃.

The first subsystem (T₁) in the beam path of the objective may be designed such that the beams emanating from the specimen are deflected in the first subsystem (T₁).

The first subsystem (T₁) may have a cemented element (KG1). The cemented element KG1 may be a cemented doublet element. It may form a front group of the objective.

The first subsystem T₁ may have at least one, such as two or more, singlet lenses (L3, L4) downstream of the cemented element KG1.

It has been found to be desirable for there to be two singlet lenses L3, L4 downstream of the front group of the first subsystem T₁. This can help make it possible for the beams to be very strongly deflected. Downstream thereof is a negative cemented group KG2, with a correspondingly strong negative refractive power in the diverging lens in order to already help compensate for lateral chromatic aberration.

The first subsystem T₁ may also have a second cemented element KG2.

The first subsystem may have an opened-up triplet group comprising the singlet lens L4 and the cemented doublet element KG2.

The opened-up triplet group is a group of three lenses that is formed from a cemented triplet element by increasing the image-side radius of curvature of the first lens. This can create an air gap between the first lens L4 and the cemented doublet element KG2. The air gap between the singlet lens L4 and the cemented doublet element KG2 can become narrower towards the edge.

Within the opened-up triplet group, there may be steep angles of incidence on the cemented doublet element KG2.

The absolute value of the radius of curvature |r7| of the surface (FL7) of the singlet lens L4 facing the cemented doublet element KG2 may be greater than the absolute value of the radius of curvature |r8| of the surface FL8 of the cemented doublet element KG2 facing the singlet lens L4, |r7|>|r8|.

The lens L4 may be a biconvex lens.

The cemented doublet element KG2 may have a negative focal length, f′(KG2)<0.

The second subsystem T₂ may have a cemented element KG3, the lenses of which are made of different materials, wherein the difference

|Δnₑ| between the refractive indices of the materials is large, such as at least 0.3. This can help provide compensation options for correcting higher-order image aberrations, such as for off-axis beams.

The second subsystem T₂ may also have a second cemented group KG4, the cemented surface of which has a radius of curvature r(KG4) that is smaller than a radius of curvature r(KG3) of the cemented surface of the front cemented element (KG3), in the beam path, of the second subsystem.

The refractive index difference of the materials of the second cemented element (KG4) of the second subsystem may be smaller than that of the front cemented element KG3 of the second subsystem T₂. The refractive index difference of the rear cemented element KG4 may, in terms of absolute value, be less than 0.25.

At least one, for example both, of the cemented elements KG3, KG4 of the second subsystem T₂ may have diverging cemented surfaces.

A diverging cemented surface is understood here to mean a surface that is between two media with refractive indices n1, n2 and fulfils the following condition: (n2−n1)/r_{KF}<0, where r_{KF} indicates the radius of curvature of the cemented surface. For a converging cemented surface, the following applies accordingly: (n2−n1)/r_{KF}>0.

The first subsystem T₁ may comprise (or consist of) the cemented doublet element KG1, the two singlet lenses L3 and L4 and the cemented doublet element KG2.

The objective may have a second subsystem T₂, such as downstream, for example directly downstream, of the first subsystem T₁. The second subsystem may have significantly less refractive power than the first subsystem T₁.

The second subsystem T₂ may have a cemented element, such as a cemented doublet element (KG3, KG4). For example, the second subsystem T₂ may have two cemented elements, such as two cemented doublet elements (KG3, KG4). It may comprise (or consist of) these two cemented elements.

The objective may have a third subsystem T₃, in which the beams are collimated.

The beam deflection from the first subsystem T₁ can be cancelled out in the third subsystem T₃.

The third subsystem T₃ may have multiple cemented elements. The last two cemented elements (KG6, KG7) of the third subsystem T₃ may have converging cemented surfaces.

The third subsystem T₃ may have three cemented elements (KG5, KG6 and KG7).

The third subsystem T₃ may have one cemented element (KG5) with a diverging cemented surface and, downstream thereof in the beam path, two cemented elements (KG6 and KG7) with converging cemented surfaces.

The third subsystem T₃ may comprise (or consist of) three such cemented elements KG5, KG6 and KG7.

According to an aspect, the third subsystem T₃ may have a diverging lens (L14) made of a weakly dispersive material. For example, the diverging lens L14 may be made of a material with an Abbe number vₑ>60. For example, the diverging lens L14 may be the rear lens, in the beam path, in the second cemented element (KG6) of the third subsystem T₃. It has been shown that this can eliminate the chromatic spherical aberration over a wide spectral range.

The front cemented group (KG5) of the third subsystem T₃ may have an extreme refractive index difference |Δn|>0.3.

The rearmost cemented element (KG7) in the beam path may likewise have an extreme refractive index difference: |Δn|>0.3.

An objective may have at least two, for example at least three, cemented elements, in particular KG3, KG5 and KG7, the lenses of which in each case are made of materials that have a refractive index difference of at least 0.3, in terms of absolute value.

An objective may have design data that are reproduced in the following description of different exemplary embodiments.

Some possible aspects of the objective will be described once again in general terms hereinbelow.

An objective can be particularly suitable for scanning applications, such as laser scanning applications. It can be particularly suitable for capturing a three-dimensional specimen volume.

An objective can be particularly suitable for fluorescence applications. It can be particularly suitable for scanning specimens in applications in which an excitation beam path and an emission beam path must be brought exactly into correspondence.

An objective according to the disclosure can enable particularly high intensity in the pinhole.

For example, the first subsystem T₁, in which the beams emanating from the specimen are deflected, comprises a front group, with two singlet lenses downstream thereof.

The first subsystem T₁ may have, downstream of the front group, which may be in the form of a cemented doublet element, in the beam path, an opened-up triplet group, specifically a singlet lens L4, for example a biconvex singlet lens L4, and, downstream thereof, a cemented doublet element KG2.

An objective may be a plan objective. It may be a plan apochromatic objective, such as a plan apochromatic immersion objective, for example a plan apochromatic oil immersion objective.

In general, an objective has at least one cemented element, such as at least two cemented elements, with diverging cemented surfaces.

In general, an objective may have at least one cemented element, such as at least two cemented elements, with converging cemented surfaces.

An objective may have a plurality of cemented elements, such as a plurality of cemented doublet elements, wherein the last two cemented elements in the beam path of the objective have converging cemented surfaces.

An objective may have at least one cemented element, such as at least two cemented elements, for example at least three cemented elements, with a refractive index difference with an absolute value Δnₑ>0.3.

An objective may have at least one cemented element with a diverging cemented surface.

An objective may have at least one cemented element, such as at least two cemented elements, with converging cemented surfaces.

The second subsystem T₂ may have at least one cemented element, such as at least two cemented elements, with diverging cemented surfaces. It is possible for all of the cemented surfaces of the second subsystem T₂ to be diverging.

The third subsystem T₃ may have at least one diverging cemented surface and, downstream thereof, at least one, for example at least two, converging cemented surfaces.

### BRIEF DESCRIPTION OF THE DRAWINGS

Further details are evident from the description of these exemplary embodiments with reference to the figures, in which:

FIG. 1 schematically shows a longitudinal section through the optical elements of a microscope objective according to a first variant;

FIG. 2 schematically shows a graph of the lateral chromatic aberration of the microscope objective according to FIG. 1 as a function of the wavelength;

FIG. 3 schematically shows a longitudinal section through the optical components of a microscope objective according to another variant;

FIG. 4 schematically shows a graph of the lateral chromatic aberration of the microscope objective according to FIG. 3 as a function of the wavelength;

FIG. 5 schematically shows a graph of the longitudinal chromatic aberration of the microscope objective according to FIG. 3 as a function of the wavelength,

FIG. 6 schematically shows the curve of the Strehl ratio over the image field for different wavelengths for the objective according to FIG. 3;

FIG. 7 schematically shows the curve of the field curvature over the image field for different wavelengths for the objective according to FIG. 3;

FIG. 8 schematically shows the curves of different Nijboer-Zernike coefficients NZK over the image field at a wavelength of 546.1 nm for the objective according to FIG. 3;

FIG. 9 schematically shows the curves of different Nijboer-Zernike coefficients NZK over the image field at a wavelength of 436 nm for the objective according to FIG. 3;

FIG. 10 schematically shows the curves of different Nijboer-Zernike coefficients NZK over the image field at a wavelength of 405 nm for the objective according to FIG. 3;

FIG. 11 schematically shows a longitudinal section through the optical component parts of an objective according to another variant; and

FIG. 12 schematically shows a graph of the lateral chromatic aberration of the microscope objective according to FIG. 11 as a function of the wavelength.

### DETAILED DESCRIPTION

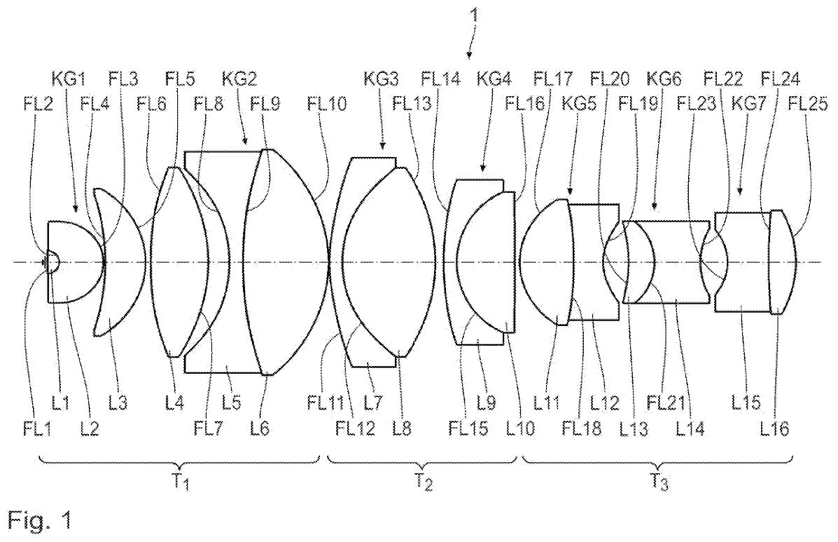

FIG. 1 shows a longitudinal section through the arrangement of the optical components of an objective 1 for a microscope.

For reasons of clarity, mechanical components of the objective 1 are not shown in the figures.

The objective 1 has 16 lenses Li, i=1, . . . , 16.

The lenses Li are arranged in three subsystems T₁, T₂ and T₃.

The objective comprises nine lens groups, specifically seven cemented elements KG1 to KG7, also referred to as cemented groups, and two singlet lenses L3 and L4.

Here, the lenses Li, cemented elements KGj and subsystems T₁, T₂, T₃ are numbered in ascending order in the direction of the beam path starting from the object-side end of the objective 1.

The optical design data of the objective 1 are collated in Table 1:

TABLE 1

| | | Radius of | | | |
|---|---|---|---|---|---|
| Lens | Surface | curvature | Thickness | Refractive | Abbe number |
| Li | FL | r in mm | d in mm | index nₑ | vₑ |
| | OBJ | INF | 0.170 | 1.5256 | 54.3 |
| | 0 | INF | 0.200 | 1.5180 | 47.4 |
| L1 | 1 | INF | 0.715 | 1.5421 | 59.4 |
| L2 | 2 | −0.973 | 3.643 | 2.0091 | 28.9 |
| | 3 | −3.616 | 0.100 | 1.0000 | |
| L3 | 4 | −15.262 | 3.392 | 1.6984 | 58.8 |
| | 5 | −7.343 | 0.200 | 1.0000 | |
| L4 | 6 | +20.230 | 4.839 | 1.5302 | 76.6 |
| | 7 | −20.414 | 1.750 | 1.0000 | |
| L5 | 8 | −14.531 | 1.200 | 1.6413 | 42.2 |
| L6 | 9 | +14.987 | 7.400 | 1.5945 | 68.0 |
| | 10 | −16.538 | 0.100 | 1.0000 | |
| L7 | 11 | +71.724 | 1.100 | 1.8881 | 40.5 |
| L8 | 12 | +10.934 | 7.624 | 1.5710 | 70.9 |
| | 13 | −16.156 | 0.100 | 1.0000 | |
| L9 | 14 | +24.036 | 1.100 | 1.6413 | 42.2 |
| L10 | 15 | +7.158 | 5.500 | 1.4353 | 94.4 |
| | 16 | +312.797 | 0.384 | 1.0000 | |
| L11 | 17 | +6.995 | 5.500 | 1.4353 | 94.4 |
| L12 | 18 | −16.917 | 1.481 | 1.7434 | 32.1 |
| | 19 | +7.389 | 2.147 | 1.0000 | |
| L13 | 20 | −30.403 | 2.272 | 1.7954 | 28.2 |
| L14 | 21 | −5.947 | 3.500 | 1.4879 | 84.1 |
| | 22 | +6.349 | 3.500 | 1.0000 | |
| L15 | 23 | −5.888 | 0.900 | 1.5302 | 76.6 |
| L16 | 24 | +28.899 | 2.300 | 1.8395 | 42.5 |
| | 25 | −10.462 | 2.442 | 1.0000 | |
| | 26 | INF | 151.500 | 1.0000 | |

In particular, Table 1 shows the radius of curvature r of the boundary surfaces FLi in millimetres.

The statements regarding the refractive index nₑ and the Abbe number vₑ relate to the e-line (546.07 nm).

$${v}_{e} = \frac{{n}_{e} - 1}{{n}_{{F}^{′}} - {n}_{{C}^{′}}}$$

The objective 1 according to FIG. 1 has a numerical aperture NA=1.42.

The objective 1 according to FIG. 1 has a working distance AA=0.20 mm.

The objective 1 according to FIG. 1 has a focal length f=3.1 mm.

The absolute value of the radius of curvature r7 of the seventh surface FL7, 20.414 mm, is larger than the absolute value of the radius of curvature r8=14.531 mm of the eighth surface FL8: |r7|>|r8|.

The subsystem T₁ of the objective 1 comprises 6 lenses L1 to L6.

In particular, the first subsystem T₁ of the objective 1 comprises the first cemented element KG1 with the lenses L1 and L2, the two singlet lenses L3 and L4 and the second cemented element KG2 with the lenses L5 and L6.

The lens L4 and the cemented element KG2 form an opened-up triplet group.

The focal length of the second cemented element KG2 is −425 mm. In particular, the focal length of the second cemented element KG2 is negative.

The absolute value of the difference between the refractive indices nₑ(Li) of the lenses Li in each of the third cemented group KG3, the fifth cemented group KG5 and the seventh cemented group KG7 is greater than 0.3.

$$\vert Δ n ( KG 3 ) \vert = \vert {n}_{e} ( L 7 ) - {n}_{e} ( L8 ) \vert = 0.32 .$$

$$\vert Δ n ( KG 5 ) \vert = \vert {n}_{e} ( L 11 ) - {n}_{e} ( L 12 ) \vert = 0. 3 1.$$

$$\vert Δ n ( KG 7 ) \vert = \vert {n}_{e} ( L 15 ) - {n}_{e} ( L 16 ) \vert = 0. 31 .$$

The absolute value of the refractive index difference of the lenses L9 and L10 of the fourth cemented element KG4 is less than 0.25.

$$\vert Δ n ( KG 4 ) \vert = \vert {n}_{e} ( L 9 ) - {n}_{e} ( L 10 ) \vert = 0.21 .$$

The second subsystem T₂ comprises four lenses, L7, L8, L9 and L10.

The second subsystem T₂ comprises two cemented elements, KG3 comprising L7 and L8, and KG4 comprising L9 and L10.

The cemented surface FL12 of the third cemented element KG3 and the cemented surface FL15 of the fourth cemented element KG4 are each diverging cemented surfaces. The following applies:

(n2−n1)/r_{KF}<0, where n1 denotes the refractive index of the material of the front lens in the beam path and n2 denotes the refractive index of the lens downstream thereof and r_{KF} denotes the radius of curvature of the cemented surface.

The third subsystem T₃ comprises six lenses L11 to L16.

In particular, the third subsystem T₃ comprises three cemented elements KG5, KG6 and KG7.

The first cemented element KG5 of the third subsystem T₃ has a diverging cemented surface FL18. The two downstream cemented elements KG6 and KG7 of the third subsystem T₃ each have converging cemented surfaces FL21 and FL24.

The front cemented element, in the beam path, of the third subsystem T₃ has an extreme refractive index difference. The following applies in particular: |Δn(KG5)|>0.3.

The cemented surface FL21=r(KF6) of the sixth cemented element KG6 is a converging cemented surface.

The cemented surface FL24=r(KF7) of the seventh cemented element KG7 is a converging cemented surface.

$$r ( KF 6 ) = r 21 = - 5.947 mm ,$$

$$( {n}_{e} ( 21 ) - n e ( 20 ) ) = 1.4879 - 1.7954 = - 0.30 \; 75 ,$$

$$( n ( 21 ) - n ( 20 ) ) / r ( K F 6 ) = 0.052 > 0$$

$$r ( KF 7 ) = r 24 = 28.899 mm ,$$

$$( {n}_{e} 21 - {n}_{e} 20 ) = 1.83951 - 1.5302 = + 0.30931 ,$$

$$( n ( 21 ) - n ( 20 ) ) / r ( K F 7 ) = 0.011 > 0$$

The central cemented element KG6 of the third subsystem T₃ has a lens, L14, made of a weakly dispersive material. In particular, the lens L14 is made of a material with an Abbe number vₑ>60. In particular, the lens L14 is a diverging lens.

The last cemented element KG7 of the third subsystem T₃ has an extreme refractive index difference. The following applies in particular: |n(KG7)|>0.3.

The objective 1 according to FIG. 1 is designed for use with a tube lens system, the optical design data of which are collated in Table 2.

TABLE 2

| | Radius of | | | |
|---|---|---|---|---|
| Surface | curvature | Thickness | Refractive index | Abbe number |
| FL | r in mm | d in mm | nₑ | vₑ |
| | | 155.00 | | |
| 1 | 175.30 | 7.40 | 1.4891 | 70.2 |
| 2 | −70.29 | 2.60 | 1.6580 | 39.5 |
| 3 | −137.69 | 5.00 | | |
| 4 | INF | 45.00 | 1.5187 | 64.0 |
| 5 | INF | 157.34 | | |
| Image | | | | |

The focal length of this tube lens system is f′_{T}=195 mm.

For further details of a suitable tube lens system, reference is made by way of example to DE 10 2019 211 360 A1.

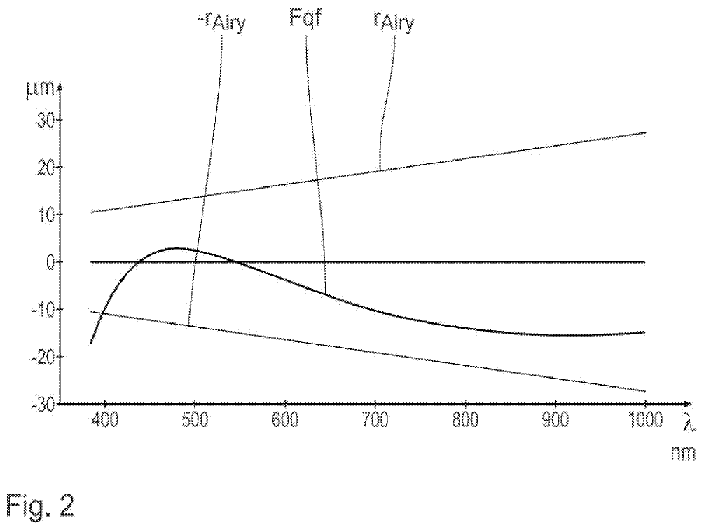

FIG. 2 shows, by way of example, the lateral chromatic aberration Fqf of the objective 1 according to FIG. 1 as a function of the wavelength.

The Airy radius r_{Airy}=±0.61 λ/NA is also shown as a comparison variable in FIG. 2.

As may be gathered from FIG. 2, the objective is corrected very well in terms of the lateral chromatic aberration over the entire wavelength range of λ=385 nm to 1000 nm.

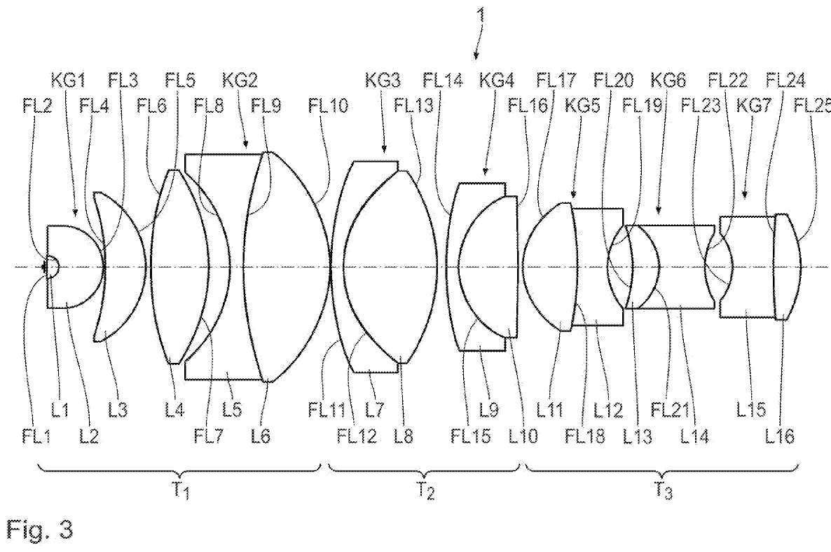

A variant of the objective 1 will be described hereinbelow with reference to FIGS. 3 to 10 and Table 3. FIG. 3 shows a longitudinal section through the arrangement of the optical components of this variant of the objective 1 for a microscope. The objective according to FIG. 3 has a fundamentally similar structure to the objective according to FIG. 1.

Corresponding components have the same reference signs as for the objective 1 according to FIG. 1. Identical properties will not be fully described again. In this respect, reference is made to the preceding description of the objective 1 according to FIG. 1.

The optical design data of the objective 1 according to FIG. 1 are collated in Table 3:

TABLE 3

| | | Radius of | | | |
|---|---|---|---|---|---|
| Lens | Surface | curvature | Thickness | Refractive | Abbe number |
| Li | FL | r in mm | d in mm | index nₑ | vₑ |
| | OBJ | INF | 0.170 | 1.5256 | 54.3 |
| | 0 | INF | 0.210 | 1.5180 | 47.4 |
| L1 | 1 | INF | 0.962 | 1.6099 | 56.4 |
| L2 | 2 | −1.031 | 3.688 | 2.0091 | 28.9 |
| | 3 | −3.704 | 0.167 | 1.0000 | |
| L3 | 4 | −21.442 | 3.391 | 1.5710 | 70.9 |
| | 5 | −7.944 | 0.418 | 1.0000 | |
| L4 | 6 | +26.224 | 4.807 | 1.5945 | 68.0 |
| | 7 | −16.549 | 1.772 | 1.0000 | |
| L5 | 8 | −11.546 | 1.100 | 1.6413 | 42.2 |
| L6 | 9 | +32.314 | 7.189 | 1.5302 | 76.6 |
| | 10 | −13.528 | 0.050 | 1.0000 | |
| L7 | 11 | +25.120 | 1.100 | 1.8881 | 40.5 |
| L8 | 12 | +10.441 | 7.789 | 1.4572 | 90.5 |
| | 13 | −16.196 | 0.736 | 1.0000 | |
| L9 | 14 | +26.037 | 1.100 | 1.6413 | 42.2 |
| L10 | 15 | +7.285 | 4.870 | 1.4399 | 94.5 |
| | 16 | −266.070 | 0.385 | 1.0000 | |
| L11 | 17 | +6.684 | 4.522 | 1.5302 | 76.6 |
| L12 | 18 | −31.395 | 2.500 | 1.8881 | 40.5 |
| | 19 | +5.788 | 2.119 | 1.0000 | |
| L13 | 20 | −13.046 | 2.200 | 1.7254 | 34.5 |
| L14 | 21 | −4.800 | 3.781 | 1.4601 | 67.7 |
| | 22 | +5.957 | 2.336 | 1.0000 | |
| L15 | 23 | −5.012 | 3.354 | 1.4399 | 94.5 |
| L16 | 24 | +46.980 | 2.300 | 1.8202 | 46.4 |
| | 25 | −11.141 | 0.545 | 1.0000 | |
| | 26 | INF | 151.500 | 1.0000 | |

The objective 1 according to FIG. 3 has a numerical aperture NA=1.42.

The objective 1 according to FIG. 3 has a working distance AA=0.21 mm.

The objective 1 according to FIG. 3 has a focal length f=3.1 mm.

The absolute value of the radius of curvature r7 of the seventh surface FL7, 16.549 mm, is larger than the absolute value of the radius of curvature r8=11.546 mm of the eighth surface FL8: |r7|>|r8|.

The focal length of the second cemented element KG2 is −132 mm. In particular, the focal length of the second cemented element KG2 is negative.

The absolute value of the difference between the refractive indices nₑ(Li) of the lenses Li in each of the third cemented group KG3, the fifth cemented group KG5 and the seventh cemented group KG7 is greater than 0.3.

$$\vert Δ n ( K G 3 ) \vert = \vert {n}_{e} ( L 7 ) - {n}_{e} ( L 8 ) \vert = 43.$$

$$\vert Δ n ( K G 5 ) \vert = \vert {n}_{e} ( L 11 ) - {n}_{e} ( L 12 ) \vert = 0.3 6.$$

$$\vert Δ n ( K G 7 ) \vert = \vert {n}_{e} ( L 15 ) - {n}_{e} ( L 16 ) \vert = 0.38 .$$

The absolute value of the refractive index difference of the lenses L9 and L10 of the fourth cemented element KG4 is less than 0.25.

$$\vert Δ n ( K G 4 ) \vert = \vert {n}_{e} ( L 9 ) - {n}_{e} ( L 10 ) \vert = 0.2 .$$

The cemented surface FL12 of the third cemented element KG3 and the cemented surface FL15 of the fourth cemented element KG4 are each diverging cemented surfaces. The following applies:

(n2−n1)/r_{KF}<0, where n1 denotes the refractive index of the material of the front lens in the beam path and n2 denotes the refractive index of the lens downstream thereof and r_{KF} denotes the radius of curvature of the cemented surface.

The cemented surface FL21=r(KF6) of the sixth cemented element KG6 is a converging cemented surface.

$$r ( KF 6 ) = r 21 = - 4.8 mm ,$$

$$( {n}_{e} ( 21 ) - {n}_{e} ( 20 ) ) = 1.4601 - 1.7254 = - 0.2653 ,$$

$$( n ( 21 ) - n ( 20 ) ) / r ( K F 6 ) = 0.055 > 0$$

$$r ( KF 7 ) = r 24 = 46.98 mm ,$$

$$( {n}_{e} 24 - {n}_{e} 23 ) = 1.8202 - 1.4399 = + 0.3803 ,$$

$$( n ( 24 ) - n ( 24 ) ) / r ( K F 7 ) = 0.008 > 0$$

The central cemented element KG6 of the third subsystem T₃ has a lens, L14, made of a weakly dispersive material. In particular, the lens L14 is made of a material with an Abbe number vₑ>60. In particular, the lens L14 is a diverging lens.

The last cemented element KG7 of the third subsystem T₃ has an extreme refractive index difference. The following applies in particular: |n(KG7)|>0.3.

The objective 1 according to FIG. 3 is designed for use with a tube lens system, the optical design data of which are collated in Table 2.

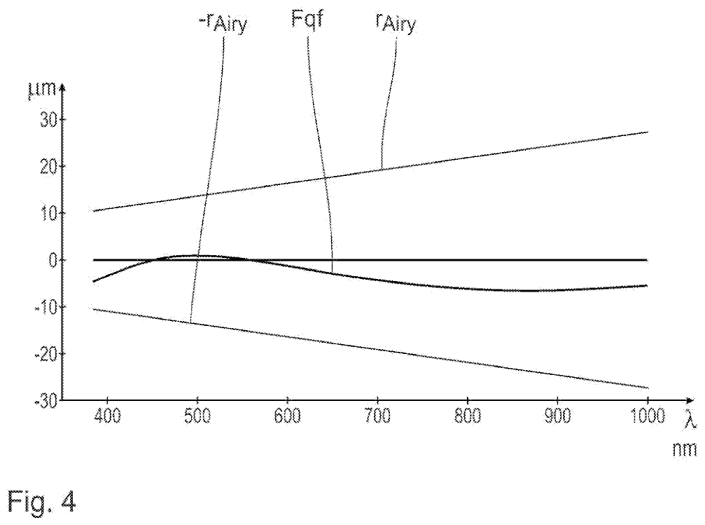

FIG. 4 shows, by way of example, the lateral chromatic aberration Fqf of the objective 1 according to FIG. 3 as a function of the wavelength.

The Airy radius±r_{Airy}=±0.61 λ/NA is also shown as a comparison variable in FIG. 4.

As may be gathered from FIG. 4, the objective is corrected very well in terms of the lateral chromatic aberration over the entire wavelength range of λ=385 nm to 1000 nm. The following applies: |Fqf|<0.3 r_{Airy}.

The objective 3 according to FIG. 3 has excellent correction of the lateral chromatic aberration, in particular in the wavelength range of λ=430 nm to 610 nm, in particular λ=450 nm to 600 nm.

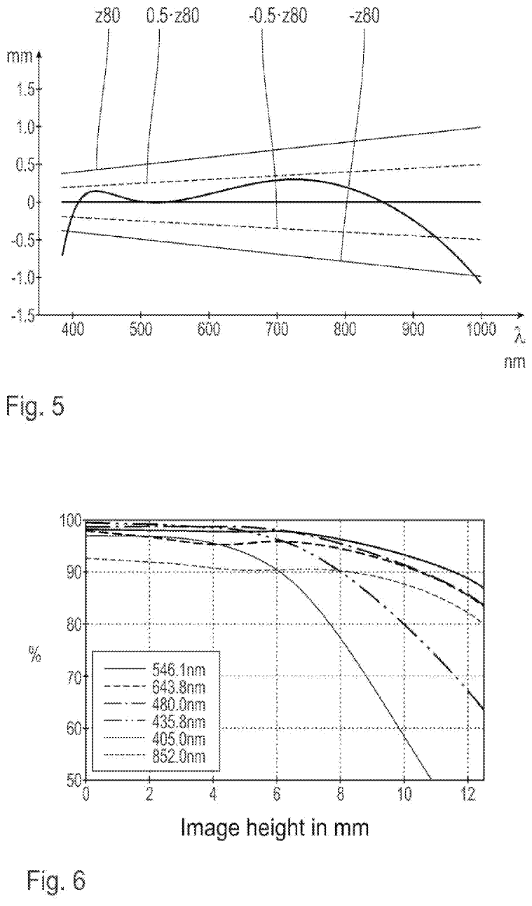

As may be gathered from FIG. 5, the objective is corrected very well in terms of the longitudinal chromatic aberration FLF over a wavelength range of λ=405 nm to 900 nm. The following applies in particular: |FLF|≤0.5·z80.

The objective 1 has a high image quality. The Strehl ratio DEH over the image field height is shown by way of example as an image quality criterion in FIG. 6.

As may be gathered from FIG. 6, the objective is corrected such that the Strehl ratio in the image plane up to an image field of at least two-thirds of the full field of view is above a value of 75% for all wavelengths in the range from 400 nm to 900 nm. In the wavelength range of λ=450 nm to 900 nm, the Strehl ratio in the entire field of view SF25 is above 80%.

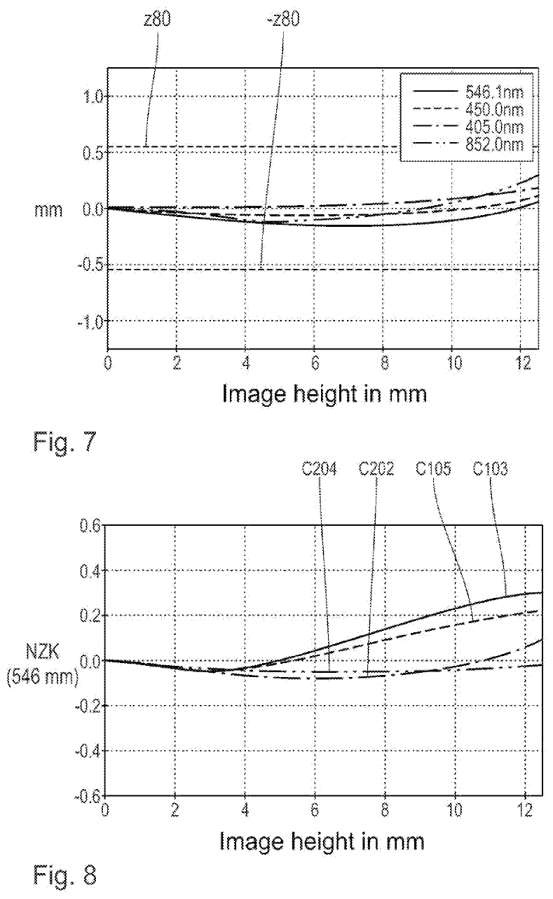

The image quality achieved with the objective according to the disclosure is also apparent from the very low field curvature BFW. This is shown by way of example in FIG. 7 for the objective 1 according to FIG. 3. ±0.5·z80 is plotted as a comparison value in FIG. 7. The absolute value of the field curvature is significantly less than 0.5·z80 over the entire field of view SF25. It is less than 0.3·z80 over more than 80% of the full field of view SF25.

The values of the Nijboer-Zernike coefficients C103, C105, C202 and C204 over the image field height are shown in FIGS. 8 to 10. The Nijboer-Zernike coefficients C103 and C105 can be used to quantify the coma.

The Nijboer-Zernike coefficients C202 and C204 can be used to quantify the astigmatism.

The coefficients C103, C105, C202 and C204 are very small for all wavelengths in the range from 450 nm to 900 nm, in particular for the wavelengths 546.1 nm, 436 nm and 405 nm shown in FIGS. 8 to 10.

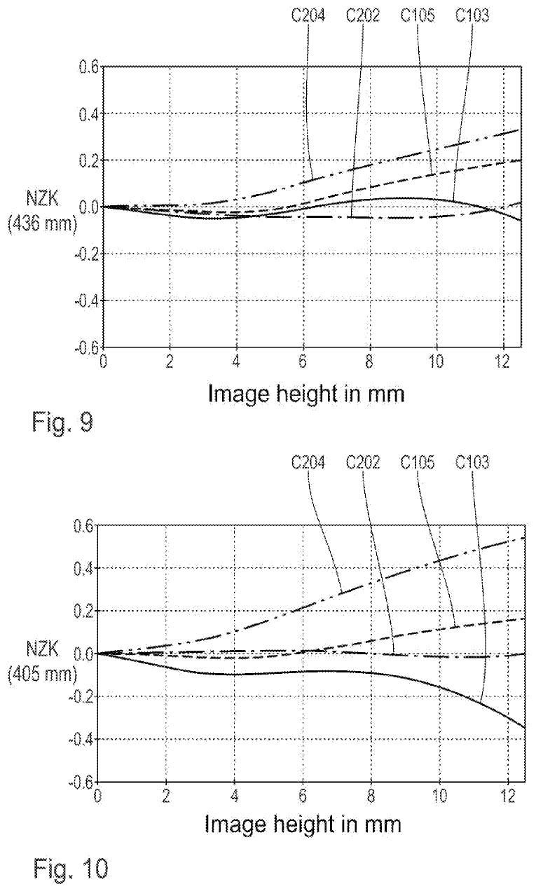

While the correction is dominated by the curve of the coma coefficient C103 at the reference wavelength λ=546.1 nm (FIG. 8), the disturbing influence of the secondary astigmatism, which is quantified in particular by the Nijboer-Zernike coefficient C204, can be maintained at values of less than 0.6 for the wavelengths λ=436 nm (FIG. 9) and λ=405 nm (FIG. 10): |C204|<0.6.

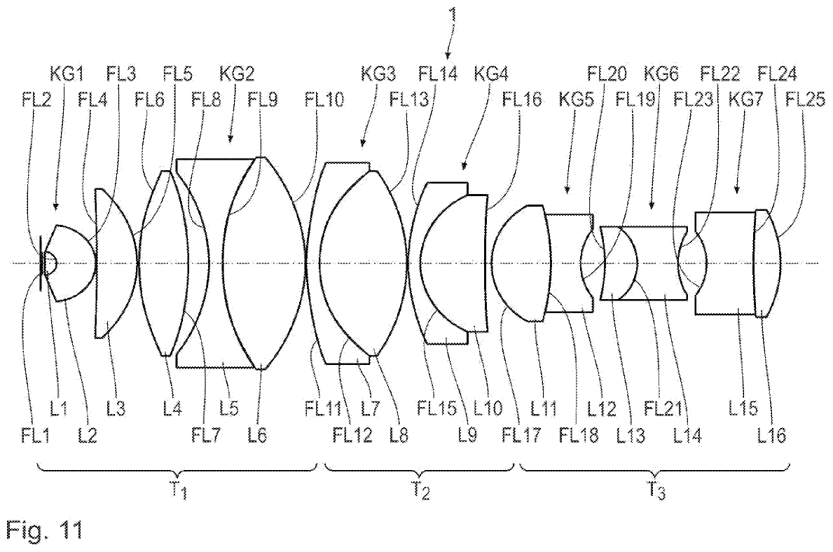

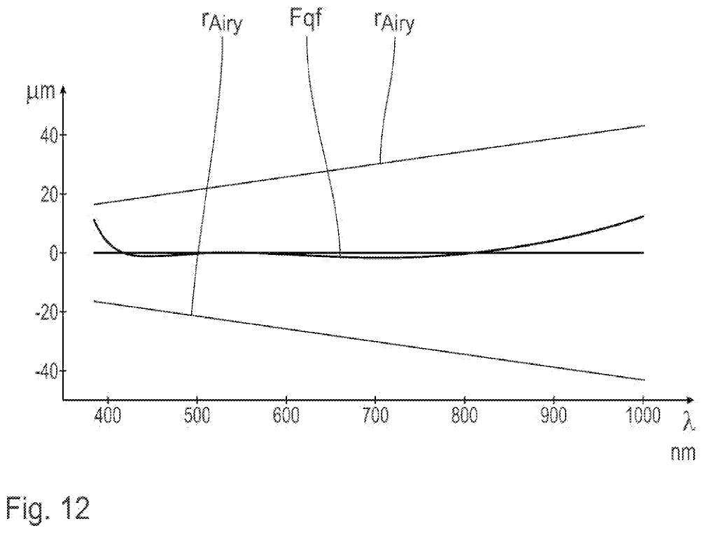

Another variant of the objective 1 will be described hereinbelow with reference to FIGS. 11 and 12 and Tables 4 and 5.

A variant of the objective 1 will be described hereinbelow with reference to FIGS. 3 to 10 and Table 3. FIG. 4 shows a longitudinal section through the arrangement of the optical components of this variant of the objective 1 for a microscope. The objective according to FIG. 4 has a fundamentally similar structure to the objective according to FIG. 1. Corresponding components have the same reference signs as for the objective 1 according to FIG. 1. Identical properties will not be fully described again. In this respect, reference is made to the preceding description of the objective 1 according to FIG. 1. FIG. 11 shows a longitudinal section through the arrangement of the optical components of this variant of the objective 1 for a microscope.

The optical design data of the objective 1 according to FIG. 1 are collated in Table 4:

TABLE 4

| | | Radius of | | | |
|---|---|---|---|---|---|
| Lens | Surface | curvature r | Thickness | Refractive | Abbe number |
| li | FL | in mm | d in mm | index nₑ | vₑ |
| | OBJ | INF | 0.170 | 1.5256 | 54.3 |
| | 0 | INF | 0.210 | 1.5180 | 47.4 |
| L1 | 1 | INF | 0.995 | 1.5821 | 53.6 |
| L2 | 2 | −1.031 | 3.357 | 2.0091 | 28.9 |
| | 3 | −3.354 | 0.100 | 1.0000 | |
| L3 | 4 | −174.819 | 3.442 | 1.4879 | 84.1 |
| | 5 | −9.026 | 0.200 | 1.0000 | |
| L4 | 6 | +19.114 | 4.200 | 1.5302 | 76.6 |
| | 7 | −23.133 | 1.750 | 1.0000 | |
| L5 | 8 | −13.462 | 1.200 | 1.6413 | 42.2 |
| L6 | 9 | +17.320 | 7.100 | 1.5710 | 70.9 |
| | 10 | −15.088 | 0.100 | 1.0000 | |
| L7 | 11 | +25.508 | 1.100 | 1.8364 | 52.3 |
| L8 | 12 | +10.056 | 7.500 | 1.4399 | 94.5 |
| | 13 | −14.549 | 0.100 | 1.0000 | |
| L9 | 14 | +16.423 | 1.100 | 1.6413 | 42.2 |
| L10 | 15 | +6.704 | 5.500 | 1.4399 | 94.5 |
| | 16 | +72.751 | 0.570 | 1.0000 | |
| L11 | 17 | +5.934 | 5.100 | 1.4399 | 94.5 |
| L12 | 18 | −20.233 | 2.500 | 1.9105 | 31.1 |
| | 19 | +5.033 | 2.100 | 1.0000 | |
| L13 | 20 | −14.867 | 2.800 | 1.7254 | 34.5 |
| L14 | 21 | −4.084 | 3.484 | 1.4601 | 67.7 |
| | 22 | +5.649 | 2.423 | 1.0000 | |
| L15 | 23 | −4.987 | 4.059 | 1.4399 | 94.5 |
| L16 | 24 | +59.379 | 2.300 | 1.8202 | 46.4 |
| | 25 | −10.744 | 0.100 | 1.0000 | |

The objective 1 according to FIG. 11 has a numerical aperture NA=1.42.

The objective 1 according to FIG. 11 has a working distance AA=0.21 mm.

The objective 1 according to FIG. 11 has a focal length f=3.1 mm.

The absolute value of the radius of curvature r7 of the seventh surface FL7, 23.133 mm, is larger than the absolute value of the radius of curvature r8=13.462 mm of the eighth surface FL8: |r7|>|r8|.

The focal length of the second cemented element KG2 is −262 mm. In particular, the focal length of the second cemented element KG2 is negative.

The absolute value of the difference between the refractive indices nₑ(Li) of the lenses Li in each of the third cemented group KG3, the fifth cemented group KG5 and the seventh cemented group KG7 is greater than 0.3.

$$\vert Δ n ( K G 3 ) \vert = \vert {n}_{e} ( L 7 ) - {n}_{e} ( L 8 ) \vert = 0.4 .$$

$$\vert Δ n ( K G 5 ) \vert = \vert {n}_{e} ( L 11 ) - {n}_{e} ( L 12 ) \vert = 0 47.$$

$$\vert Δ n ( K G 7 ) \vert = \vert {n}_{e} ( L 15 ) - {n}_{e} ( L 16 ) \vert = 0.38 .$$

The absolute value of the refractive index difference of the lenses L9 and L10 of the fourth cemented element KG4 is less than 0.25.

$$\vert Δ n ( K G 4 ) \vert = \vert {n}_{e} ( L 9 ) - {n}_{e} ( L 10 ) \vert = 0.2 .$$

The cemented surface FL12 of the third cemented element KG3 and the cemented surface FL15 of the fourth cemented element KG4 are each diverging cemented surfaces. The following applies:

(n2−n1)/r_{KF}<0, where n1 denotes the refractive index of the material of the front lens in the beam path and n2 denotes the refractive index of the lens downstream thereof and r_{KF} denotes the radius of curvature of the cemented surface.

The cemented surface FL21=r(KF6) of the sixth cemented element KG6 is a converging cemented surface.

$$r ( KF 6 ) = r 21 = - 4.084 mm ,$$

$$( {n}_{e} ( 21 ) - {n}_{e} ( 20 ) ) = 1.4601 - 1.7254 = - 0.2653 ,$$

$$( n ( 21 ) - n ( 20 ) ) / r ( K F 6 ) = 0.065 > 0$$

$$r ( KF 7 ) = r 24 = 59.379 mm ,$$

$$( {n}_{e} 24 - {n}_{e} 23 ) = 1.8202 - 1.4399 = + 0.38 \; 03 ,$$

$$( n ( 24 ) - n ( 24 ) ) / r ( K F 7 ) = 0.006 > 0$$

The central cemented element KG6 of the third subsystem T₃ has a lens, L14, made of a weakly dispersive material. In particular, the lens L14 is made of a material with an Abbe number vₑ>60. In particular, the lens L14 is a diverging lens.

The last cemented element KG7 of the third subsystem T₃ has an extreme refractive index difference. The following applies in particular: |n(KG7)|>0.3.

In contrast to the two variants according to FIGS. 1 and 3, the objective 1 according to FIG. 11 (Table 4) is designed for a tube lens system with the system data specified in Table 5.

TABLE 5

| | Radius of | | | |
|---|---|---|---|---|
| Surface | curvature r in | Thickness d | Refractive | Abbe number |
| FL | mm | in mm | index nₑ | vₑ |
| | | 150.00 | | |
| 1 | 415.67 | 6.40 | 1.6776 | 32.0 |
| 2 | 139.24 | 12.50 | 1.5187 | 64.0 |
| 3 | −188.36 | 307.03 | | |
| Image | | | | |

This tube lens system is an achromat. The tube lens system with the system data according to Table 5 has a focal length f′_{T}=310 mm.

The focal length of this tube lens system is f′_{T}=310 mm.

FIG. 12 shows, by way of example, the lateral chromatic aberration Fqf of the objective 1 according to FIG. 11 as a function of the wavelength.

The Airy radius r_{Airy}=±0.61 λ/NA is also shown as a comparison variable in FIG. 12.

As may be gathered from FIG. 12, the objective is corrected very well in terms of the lateral chromatic aberration over the entire wavelength range of λ=385 nm to 1000 nm.

The following applies: |Fqf|<0.3 r_{Airy}.

The objective 1 according to FIG. 11 has excellent correction of the lateral chromatic aberration, in particular in the wavelength range of λ=410 nm to 840 nm, in particular λ=450 nm to 600 nm.

As may be gathered from FIG. 12, the lateral chromatic aberration Fqf of the objective 1 according to FIG. 11 is almost entirely corrected over a very wide wavelength range, in particular over a wavelength range from λ=410 nm to λ=840 nm.

Some general properties and advantages of the different variants of the objective 1 (FIG. 1, Table 1, FIG. 3, Table 3, FIG. 11, Table 4) will be summarized once again hereinbelow.

In particular, the objective 1 is an apochromatic immersion objective.

In particular, the objective 1 is intended for use with standard immersion oil (nₑ=1.5180; vₑ=47.4).

The objective 1 has a numerical aperture NA of more than 1.4, in particular of at least 1.42.

The objective 1 has a large working distance AA. In particular, the working distance AA is at least 0.18 mm. It may also be 0.20 or 0.21 mm.

Depending on the tube lens focal length, the magnification of the objective 1 can range from 50× to 75×.

The objective 1 has excellent chromatic correction, in particular for the lateral chromatic aberration.

The objective 1 has very good apochromatic correction, in particular over a very wide wavelength range, in particular over a bandwidth of at least 100 nm, in particular at least 150 nm, in particular at least 250 nm, in particular at least 400 nm, in particular at least 600 nm. Lateral chromatic aberrations can be corrected so well over the entire specified wavelength range that they are at most 0.3 times, in particular at most 0.2 times, in particular at most 0.1 times the Airy diameter.

Longitudinal chromatic aberrations are, in terms of absolute value, at most half a Rayleigh length z80 in the specified wavelength range and in particular in the wavelength range from 405 nm to 900 nm.

In particular, the objective 1 has excellent monochromatic correction.

The specified design makes it possible for the Strehl ratio DEH to have a value of at least 75% up to an image field of two-thirds of the full field of view for all wavelengths in the range from 400 nm to 900 nm in the image plane. A Strehl ratio DEH of above 80% can be achieved for the complete field of view with a diameter of 25 mm for the wavelength range from 450 nm to 900 nm.

The absolute value of the field curvature BFW is at most half the Rayleigh length z80 for all wavelengths in the specified range, in particular for λ=405.0 nm, λ=450.0 nm, λ=546.1 nm and λ=852.0 nm: |BFW|<0.5·z80. Up to a field of view of at least ⅘ of the full field of view SF25, the following applies: |BFW|<0.3·z80.

The objective 1 has excellent coma correction. The absolute value of the Nijboer-Zernike coefficients for describing the coma, C103 and C105, is, over at least 95% of the field of view SF25, less than 0.3 for all wavelengths in the specified wavelength range, in particular for λ=405 nm, λ=436 and λ=546 nm.

The objective 1 has excellent astigmatism correction. The absolute value of the Nijboer-Zernike coefficients for describing the astigmatism, C202 and C204, is, over at least 95% of the field of view, in particular over the entire field of view SF25, at most 0.6 in the specified wavelength range, in particular for λ=405 nm, λ=436 nm and λ=546 nm, and at most 0.4 in the range starting from 436 nm.

What is claimed is:

1. An objective, comprising:
a plurality of lenses which define multiple subsystems comprising a first subsystem, each subsystem comprising a plurality of lens groups,
wherein:
the first subsystem comprises an opened-up triplet group which comprises a singlet lens and a cemented doublet element;
an absolute value of a radius of curvature of a surface of the singlet lens facing the cemented doublet element is greater than an absolute value of a radius of curvature of a surface of the cemented doublet element facing the singlet lens;
a plurality of the lenses define cemented elements;
a plurality of the cemented elements comprise lenses which comprise glasses with a refractive index difference greater than 0.3;
at least two cemented elements comprise converging cemented surfaces; and
the objective is an apochromatic immersion objective.

2. The objective of claim 1, wherein the cemented doublet element has a negative focal length.

3. The objective of claim 1, wherein the multiple subsystems comprise a second subsystem, and the second subject system comprises two cemented elements.

4. The objective of claim 1, wherein the multiple subsystems comprise a third subsystem, and the third subsystem comprises three cemented elements.

5. The objective of claim 1, wherein the last two cemented elements of the cemented element along a beam path of the objective comprise converging cemented surfaces.

6. The objective of claim 1, wherein:
the multiple subsystems comprise a third subsystem; and
the third subsystem comprises:
a cemented element comprising a diverging cemented surface; and
two cemented elements comprising converging cemented surfaces which are downstream of the cemented element comprising the diverging cemented surface.

7. The objective of claim 1, wherein the multiple subsystems comprise a third subsystem, and the third subsystem comprises a diverging lens comprising a material having an Abbe number greater than 60.

8. The objective of claim 1, wherein objective has the following optical design data:

| | | Radius of | | | |
|---|---|---|---|---|---|
| Lens | Surface | curvature | Thickness d | Refractive | Abbe number |
| Li | FL | r in mm | in mm | index nₑ | vₑ |
| | OBJ | INF | 0.170 | 1.5256 | 54.3 |
| | 0 | INF | 0.200 | 1.5180 | 47.4 |
| L1 | 1 | INF | 0.715 | 1.5421 | 59.4 |
| L2 | 2 | −0.973 | 3.643 | 2.0091 | 28.9 |
| | 3 | −3.616 | 0.100 | 1.0000 | |
| L3 | 4 | −15.262 | 3.392 | 1.6984 | 58.8 |
| | 5 | −7.343 | 0.200 | 1.0000 | |
| L4 | 6 | +20.230 | 4.839 | 1.5302 | 76.6 |
| | 7 | −20.414 | 1.750 | 1.0000 | |
| L5 | 8 | −14.531 | 1.200 | 1.6413 | 42.2 |
| L6 | 9 | +14.987 | 7.400 | 1.5945 | 68.0 |
| | 10 | −16.538 | 0.100 | 1.0000 | |
| L7 | 11 | +71.724 | 1.100 | 1.8881 | 40.5 |
| L8 | 12 | +10.934 | 7.624 | 1.5710 | 70.9 |
| | 13 | −16.156 | 0.100 | 1.0000 | |
| L9 | 14 | +24.036 | 1.100 | 1.6413 | 42.2 |
| L10 | 15 | +7.158 | 5.500 | 1.4353 | 94.4 |
| | 16 | +312.797 | 0.384 | 1.0000 | |
| L11 | 17 | +6.995 | 5.500 | 1.4353 | 94.4 |
| L12 | 18 | −16.917 | 1.481 | 1.7434 | 32.1 |
| | 19 | +7.389 | 2.147 | 1.0000 | |
| L13 | 20 | −30.403 | 2.272 | 1.7954 | 28.2 |
| L14 | 21 | −5.947 | 3.500 | 1.4879 | 84.1 |
| | 22 | +6.349 | 3.500 | 1.0000 | |
| L15 | 23 | −5.888 | 0.900 | 1.5302 | 76.6 |
| L16 | 24 | +28.899 | 2.300 | 1.8395 | 42.5 |
| | 25 | −10.462 | 2.442 | 1.0000 | |
| | 26 | INF | 151.500 | 1.0000 | |

9. The objective of claim 1, wherein objective has the following optical design data:

| | | Radius of | | Refractive | |
|---|---|---|---|---|---|
| Lens | Surface | curvature | Thickness | index | Abbe number |
| Li | FL | r in mm | d in mm | nₑ | vₑ |
| | OBJ | INF | 0.170 | 1.5256 | 54.3 |
| | 0 | INF | 0.210 | 1.5180 | 47.4 |
| L1 | 1 | INF | 0.962 | 1.6099 | 56.4 |
| L2 | 2 | −1.031 | 3.688 | 2.0091 | 28.9 |
| | 3 | −3.704 | 0.167 | 1.0000 | |
| L3 | 4 | −21.442 | 3.391 | 1.5710 | 70.9 |
| | 5 | −7.944 | 0.418 | 1.0000 | |
| L4 | 6 | +26.224 | 4.807 | 1.5945 | 68.0 |
| | 7 | −16.549 | 1.772 | 1.0000 | |
| L5 | 8 | −11.546 | 1.100 | 1.6413 | 42.2 |
| L6 | 9 | +32.314 | 7.189 | 1.5302 | 76.6 |
| | 10 | −13.528 | 0.050 | 1.0000 | |
| L7 | 11 | +25.120 | 1.100 | 1.8881 | 40.5 |
| L8 | 12 | +10.441 | 7.789 | 1.4572 | 90.5 |
| | 13 | −16.196 | 0.736 | 1.0000 | |
| L9 | 14 | +26.037 | 1.100 | 1.6413 | 42.2 |
| L10 | 15 | +7.285 | 4.870 | 1.4399 | 94.5 |
| | 16 | −266.070 | 0.385 | 1.0000 | |
| L11 | 17 | +6.684 | 4.522 | 1.5302 | 76.6 |
| L12 | 18 | −31.395 | 2.500 | 1.8881 | 40.5 |
| | 19 | +5.788 | 2.119 | 1.0000 | |
| L13 | 20 | −13.046 | 2.200 | 1.7254 | 34.5 |
| L14 | 21 | −4.800 | 3.781 | 1.4601 | 67.7 |
| | 22 | +5.957 | 2.336 | 1.0000 | |
| L15 | 23 | −5.012 | 3.354 | 1.4399 | 94.5 |
| L16 | 24 | +46.980 | 2.300 | 1.8202 | 46.4 |
| | 25 | −11.141 | 0.545 | 1.0000 | |
| | 26 | INF | 151.500 | 1.0000 | |

10. The objective of claim 1, wherein objective has the following optical design data:

| | | Radius of | | | |
|---|---|---|---|---|---|
| Lens | Surface | curvature | Thickness | Refractive | Abbe number |
| Li | FL | r in mm | d in mm | index nₑ | vₑ |
| | OBJ | INF | 0.170 | 1.5256 | 54.3 |
| | 0 | INF | 0.210 | 1.5180 | 47.4 |
| L1 | 1 | INF | 0.995 | 1.5821 | 53.6 |
| L2 | 2 | −1.031 | 3.357 | 2.0091 | 28.9 |
| | 3 | −3.354 | 0.100 | 1.0000 | |
| L3 | 4 | −174.819 | 3.442 | 1.4879 | 84.1 |
| | 5 | −9.026 | 0.200 | 1.0000 | |
| L4 | 6 | +19.114 | 4.200 | 1.5302 | 76.6 |
| | 7 | −23.133 | 1.750 | 1.0000 | |
| L5 | 8 | −13.462 | 1.200 | 1.6413 | 42.2 |
| L6 | 9 | +17.320 | 7.100 | 1.5710 | 70.9 |
| | 10 | −15.088 | 0.100 | 1.0000 | |
| L7 | 11 | +25.508 | 1.100 | 1.8364 | 52.3 |
| L8 | 12 | +10.056 | 7.500 | 1.4399 | 94.5 |
| | 13 | −14.549 | 0.100 | 1.0000 | |
| L9 | 14 | +16.423 | 1.100 | 1.6413 | 42.2 |
| L10 | 15 | +6.704 | 5.500 | 1.4399 | 94.5 |
| | 16 | +72.751 | 0.570 | 1.0000 | |
| L11 | 17 | +5.934 | 5.100 | 1.4399 | 94.5 |
| L12 | 18 | −20.233 | 2.500 | 1.9105 | 31.1 |
| | 19 | +5.033 | 2.100 | 1.0000 | |
| L13 | 20 | −14.867 | 2.800 | 1.7254 | 34.5 |
| L14 | 21 | −4.084 | 3.484 | 1.4601 | 67.7 |
| | 22 | +5.649 | 2.423 | 1.0000 | |
| L15 | 23 | −4.987 | 4.059 | 1.4399 | 94.5 |
| L16 | 24 | +59.379 | 2.300 | 1.8202 | 46.4 |
| | 25 | −10.744 | 0.100 | 1.0000 | |

11. The objective of claim 1, wherein, in a wavelength range from 385 nm to 1000 nm, a lateral chromatic aberration of the objective is at most half an Airy diameter of the objective.

12. The objective of claim 1, wherein the objective has:
a magnification in a range from 50 to 75;
a numerical aperture of at least 1.4; and
a working distance of at least 0.18 mm.

13. The objective of claim 1, wherein:
the multiple subsystems comprise a second subsystem;
the second subject system comprises two cemented elements;
the multiple subsystems comprise a third subsystem; and
the third subsystem comprises three cemented elements.

14. The objective of claim 1, wherein:
the multiple subsystems comprise a second subsystem;
the second subject system comprises two cemented elements;
the multiple subsystems comprise a third subsystem; and
the third subsystem comprises:
a cemented element comprising a diverging cemented surface; and
two cemented elements comprising converging cemented surfaces which are downstream of the cemented element comprising the diverging cemented surface.

15. The objective of claim 1, wherein:
the multiple subsystems comprise a second subsystem;
the second subject system comprises two cemented elements;
the multiple subsystems comprise a third subsystem; and
the third subsystem comprises a diverging lens comprising a material having an Abbe number greater than 60.

16. The objective of claim 15, wherein the third subsystem comprises:
a cemented element comprising a diverging cemented surface; and
two cemented elements comprising converging cemented surfaces which are downstream of the cemented element comprising the diverging cemented surface.

17. The objective of claim 15, wherein the third subsystem comprises three cemented elements.

18. The objective of claim 1, wherein:
in a wavelength range from 385 nm to 1000 nm, a lateral chromatic aberration of the objective is at most half an Airy diameter of the objective; and
the objective has:
a magnification in a range from 50 to 75;
a numerical aperture of at least 1.4; and
a working distance of at least 0.18 mm.

19. The objective of claim 18, wherein the cemented doublet element has a negative focal length.

20. A microscope, comprising:
an objective according to claim 1.
